(19) United States
(12) Patent Application Publication
(10) Pub. No.: US 2008/0222932 A1
(43) Pub. Date: Sep. 18, 2008

(54) Display cabinet for light emitting diode lights and method of use

(76) Inventors: Peng Yun, Wuzhou City (CN); He Mingyue, Duyun City (CN); Huang Dasen, Heyuan City (CN)

Correspondence Address: CLARK & BRODY, 1090 VERMONT AVENUE, NW, SUITE 250, WASHINGTON, DC, 20005, US

(21) Appl. No.: 12/073,589

(22) Filed: Mar. 7, 2008

Related U.S. Application Data
(60) Provisional application No. 60/905,909, filed on Mar. 9, 2007.

(51) Int. Cl. G09F 13/00

(52) U.S. Cl. 40/541; 454/184

(57) ABSTRACT

An LED light display cabinet include a fan mounted in the interior of a cabinet housing. The fan draws air into the housing via one or more outside air inlets, and exhausts it to atmosphere via a chamber. A chamber is formed adjacent the rear door of cabinet and includes an opening in communication with the fan outlet and includes second air inlets, and baffles. The chamber permits outside air to be drawn into the chamber to cool the interior of the cabinet and exhausted out the rear of the cabinet. If the fan does not operate, air can still be drawn through the chamber for cabinet cooling.

This application claims priority under 35 U.S.C. § 119(e) based on provisional patent application No. 60/905,909, filed on Mar. 9, 2007, which is herein incorporated in its entirety by reference.

### FIELD OF THE INVENTION

This product is in the field of lighting and fixture, and particularly in the field of cabinets for light emitting diode display cabinets.

### BACKGROUND ART

In the prior art, cabinets are designed for the display of light emitting diode (LED) signs. FIG. 1 shows a typical cabinet 50 that has a housing 51 that encloses a number of components (not shown) in an interior space 52 that are used to operate the LED lights that create the signage. The housing typically has a front 53, which has the LED lights mounted thereon, and a back 55, which can include an access door (not shown) to components located inside the housing.

Some of these components, e.g., LED driver boards and a power supply 57, as well as other factors like sunshine are problematic since they generate heat and require some heat dissipation. In order to dissipate the heat, the prior art cabinet housing includes one or more air inlets 59, and a fan 61 located inside of the housing 51. A housing outlet 63 is arranged adjacent the fan outlet to allow the air pulled into the housing and through the fan to be expelled outside of the housing. Typically, the housing outlet is enclosed with a protruding baffle 65 with an open bottom 67 that directs the air in a downward direction once exiting the fan and housing outlet. The fan is typically driven by a thermostat (not shown) such that it operates when the temperature inside the housing reaches a certain level.

The protruding baffle is primarily designed to prevent rain and the like from entering the housing, thus the reason for directing the exiting air in a downward direction. One problem with this design is air exiting the housing has to pass a 90 degree turn, and this causes a slow down in the air flow and a lower cooling effect. The baffle also protrudes from the housing and creates a less than desirable look when viewing the cabinet from the rear.

Another problem with the design is that the air inlets are created by a punching operation, and this does not necessarily provide an adequate inlet area for cooling. A less than adequate air inlet area also results in compromised cooling.

Yet another problem is that the cabinet requires the operation of the fan to provide cooling. If the fan malfunctions, the cooling effect is basically negligible and the lack of cooling could damage the LED sign components.

Therefore, there is a need to provide improved LED sign cabinets and the invention responds to this need by providing such an improved cabinet.

### SUMMARY OF THE INVENTION

One object of the invention is to provide an improved LED light cabinet. The inventive LED light cabinet overcomes the drawbacks in prior art designs by providing improved cooling and an enhanced look. In addition, the inventive cabinet also allows cooling to take place even if the fan contained in housing does not work.

In one mode, the inventive cabinet is an improvement over the prior art cabinets that include a housing having a front, back, and sides, with one face of the housing having an access door, preferably at the back of the cabinet. The housing is adapted to contain one or more components to allow LED lights mounted to the housing to operate in their intended manner. According to the invention, one or more outside air inlets are mounted in the housing. A fan is provided in an interior of the housing and is in communication with the outside air inlet.

In one mode wherein the cabinet has a door on the rear of the housing, a chamber is mounted to the door, the chamber having a first inlet opening in communication with an outlet of the fan. The chamber has an exhaust opening in the door, with the chamber having a plurality of exhaust baffles arranged between the first inlet opening and the exhaust opening. The baffles assist in directing air as well as acting as a barrier to prevent entry of unwanted material such as water into the cabinet. A second air inlet of the chamber is provided in the access door to allow outside air to be drawn into the chamber by action of the fan and out of the chamber through the exhaust outlet for additional cooling of the display cabinet. The chamber 19 defines an air path, which is different than the air path created by the outside air inlet in the housing and fan.

The outside air inlet mounted in the housing can include a plurality of plates to create a plurality of openings, and a filter mesh downstream of the openings to minimize ingress of water and other unwanted materials into the housing. The second inlet openings as well as the exhaust outlet in the door can be a plurality of holes, slats or any other shaped opening.

The baffles can extend from an exterior panel of the door to form a channel between the first inlet opening and free ends of the baffles to receive outside air drawn from the second air inlet.

The invention also entails the method of using the display cabinet for lighting wherein the fan operation pulls air from the outside air inlet and exhausts it through the first inlet opening, past the baffles and out the exhaust outlet. As part of this air exhaustion, air can be drawn from the second inlet opening, through the channel and out the exhaust outlet. In addition, if the fan is not operating, heat generated by the operation of the LED lights under ambient conditions will cause air to naturally flow in the chamber, drawing air into the second inlet opening, past surfaces of the chamber for cooling, and out the exhaust outlet.

### BRIEF DESCRIPTION OF THE DRAWINGS

FIG. 1 is a schematic side view of a prior art LED display cabinet.

FIG. 2 is a schematic side view of the inventive LED display cabinet.

FIG. 3 is an exploded view of one embodiment of the inventive LED display cabinet.

FIG. 4a shows a rear view of the embodiment of FIG. 3.

FIG. 4b shows a bottom view of the embodiment of FIG. 4a.

FIG. 4c shows a top view of the embodiment of FIG. 4a.

### DESCRIPTION OF THE PREFERRED EMBODIMENTS

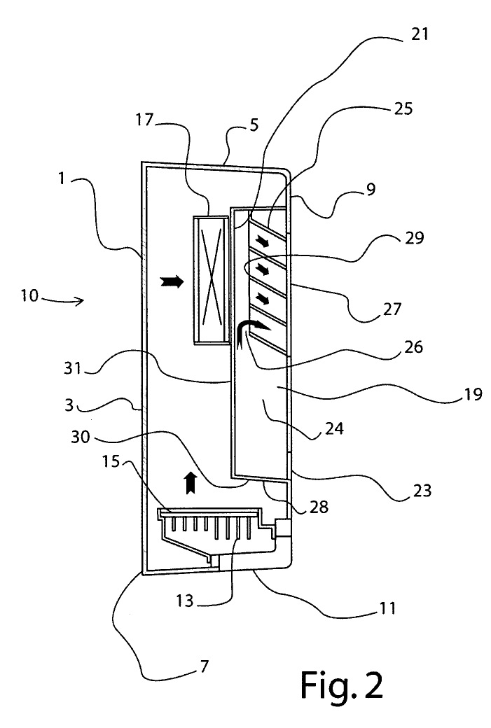

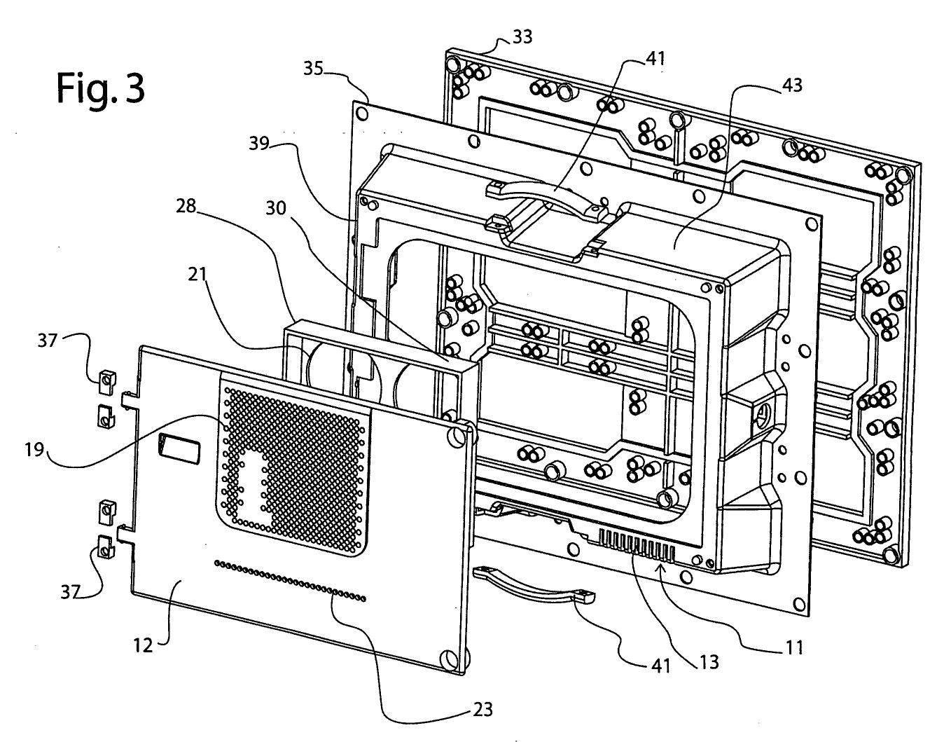

FIGS. 2-4c show one example of a display cabinet 10 for LED lights, with FIG. 2 illustrating a schematic view of the display cabinet and FIG. 3 showing one actual embodiment of the cabinet. The reference numerals for the schematic view and the actual embodiment are kept the same for ease of reference.

The cabinet includes a housing 1, having a front 3, top 5, bottom 7, and rear 9. The rear is preferably a door as is seen in FIG. 3.

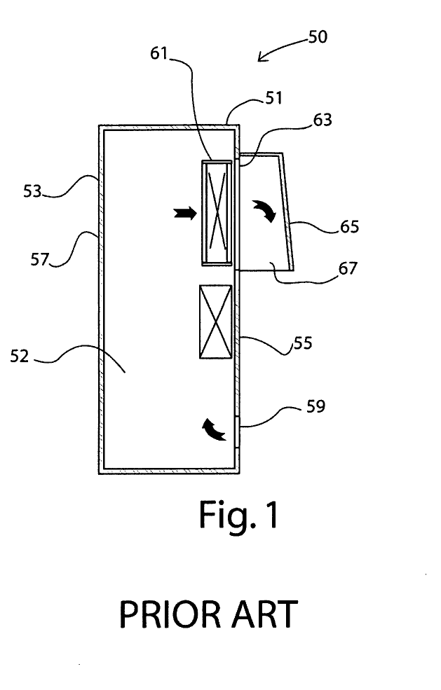

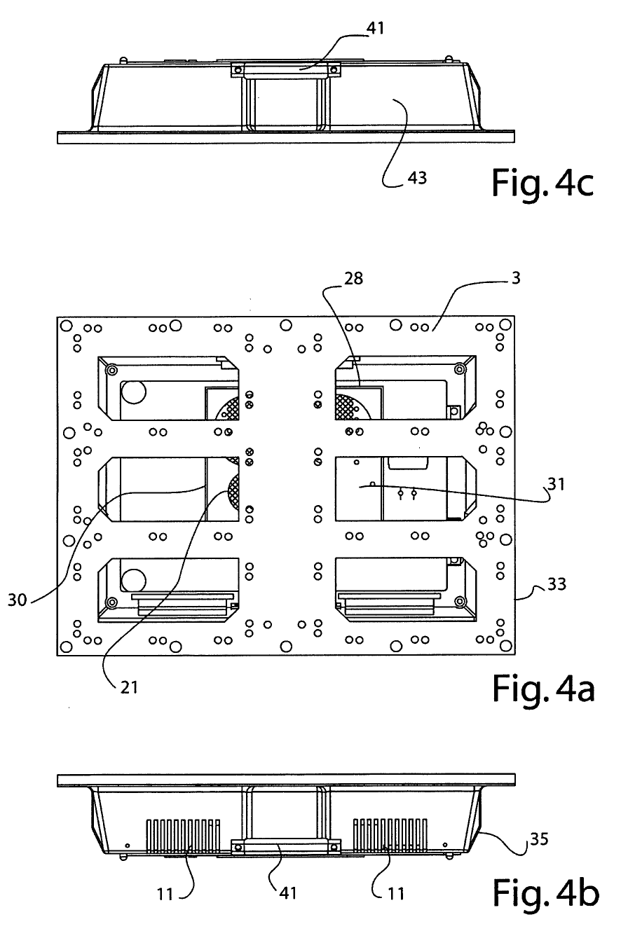

The housing 1 includes an outside air inlet 11, which can have a plurality of plates 13 and a filter mesh 15 downstream of the plates. The plates 13 function to stop sputtering water from entering the housing 1. The filter mesh, while optional, prevents entry of unwanted material into the housing as well, e.g., dust and other foreign material, water, and the like. The outside air inlet 11 is large in area and its orientation is such that flow direction into the cabinet is perpendicular to the outside air flow direction, and this reduces wind speed loss. As shown in FIG. 4b, a pair of inlets 11 can be employed but other numbers or opening configurations can also be used. The position of the air inlets 11 contrasts with the prior art cabinet of FIG. 1, wherein the outside air inlets are positioned in the rear face of the cabinet.

Besides the various components for operating the LED sign, which are not shown, the housing 1 includes one or more fans 17, which can be mounted adjacent a chamber 19, which is located in the cabinet 10. The fan outlet communicates with an opening 21 that is part of the chamber, for expelling air that is drawn through the outside air inlet 11 out of the housing 1.

The chamber 19 is configured to be inside the housing 1 but forming a distinct cavity and air flow path from the interior of the housing by reason of the bracket 28 shown in FIG. 3. The bracket 28 has sides 30 and a chamber wall 31, which form the chamber 19 with the rear 9 of the cabinet 10. The rear 9, which in one embodiment includes the cabinet door, forms another wall of the chamber, and it is this wall that contains the inlet and outlet discussed below.

The chamber includes a second air inlet 23, plurality of baffles 25, and an exhaust outlet 27. As seen in FIG. 3, the second air inlet 23 and exhaust outlet 27 are formed in the door 12 of the cabinet, but it is possible that the cabinet would have the door in a different place, and that the second air inlet and exhaust outlet were formed in a stationary wall of the chamber and/or cabinet.

As shown by the arrows in the chamber 19 in FIG. 1, outside air is drawn through the second air inlet 23, along an air path 24, and into the channel 26 created between free ends 29 of the baffles and the first air inlet 21. The chamber 19 offers supplemental cooling when the fan 17 would cease to operate. Since the inside of the housing will be generating heat, this heat will conduct through the chamber wall 31 and increase the temperature of the air in the chamber 19. This heating will create a natural flow that will draw outside air from the second air inlet 23 into the chamber 19, with the heated air flowing into the channel 26 and being exhausted out the exhaust outlet 27.

Operation of fan 17 that expels air out through the baffles 25 can also draw air from the second air inlets 23 to enhance cooling.

FIGS. 3-4c show more detail of the actual housing. The housing 1 comprises a front mask 33, a mid-cabinet 35, and the door 9, which is hinged using hinge pieces 37 and hinge areas 39 (one shown) on the mid cabinet 35. Handles 41 are provides on opposite faces 43 of the mid cabinet 35 to facilitate moving the cabinet when needed.

While the cabinet is shown with a relatively square shape, other shapes such a rectangular, octagonal, or the like could be employed. As mentioned above, the various inlets and openings depicted are only preferences and other shaped openings and placements could be used. In addition, the mid cabinet and front mask could be made integral if so desired, and the handles could be located at different locations.

As such, an invention has been disclosed in terms of preferred embodiments thereof, which fulfils each and every one of the objects of the present invention as set forth above and provides a new and improved LED light display cabinet and method of use.

Of course, various changes, modifications and alterations from the teachings of the present invention may be contemplated by those skilled in the art without departing from the intended spirit and scope thereof. It is intended that the present invention only be limited by the terms of the appended claims.

We claim:

1. In a display cabinet for an LED sign comprising a housing having a front, back, and sides, and an access door, the housing adapted to contain components for the LED sign, the improvement comprising:
at least one outside air inlet in the housing;
a fan mounted in an interior of the housing and in communication with the at least one outside air inlet;
a chamber mounted to a face of the housing, the chamber having a first inlet opening in communication with an outlet of the fan, and an exhaust outlet in the face, the chamber including a plurality of baffles arranged between the first inlet opening and the exhaust outlet; a second inlet opening formed in the chamber to allow outside air to be drawn into the chamber and exhausted through the exhaust outlet for cooling of the display cabinet.

2. The cabinet of claim 1, wherein the at least one outside air inlet mounted to the housing includes a plurality of plates and a filter mesh, the plates adapted to minimize water ingress to the interior of the housing.

3. The cabinet of claim 1, wherein the second inlet opening comprises a plurality of through holes in the chamber.

4. The cabinet of claim 1, wherein the exhaust outlet comprises a plurality of through holes in the chamber.

5. The cabinet of claim 1, wherein the baffles extend from an exterior panel of the housing so as to form a channel between the inlet opening and a free end of the baffles to receive outside air drawn from the second outside inlet.

6. The cabinet of claim 1, wherein light emitting diode devices are mounted to a front of the cabinet.

7. The cabinet of claim 1, wherein the at least one outside air inlet is positioned in a bottom of the cabinet.

8. The cabinet of claim 1, wherein plates are positioned in a vicinity of the at least one outside air inlet and the at least one outside air inlet optionally includes a filter.

9. The cabinet of claim 1, wherein the face is a door.

10. The cabinet of claim 9, wherein the face is a rear door of the cabinet.

11. In a method of cooling an LED light display cabinet, wherein air is drawn through an outside air inlet into the cabinet using a fan and exhausted out one or more openings in a cabinet face, the improvement comprising drawing air through a second air inlet along a path different from a path created by the fan to cool an interior of the cabinet, and exhausting air drawn through the second air inlet out the openings in the cabinet face.

12. The method of claim 11, wherein the second air inlet providing air to the one or more openings is located in the cabinet face.

13. The method of claim 11, wherein the cabinet face is a rear face of the cabinet.

14. The method of claim 13, wherein the rear face is an access door of the cabinet.

15. The method of claim 12, wherein the cabinet face is a rear face of the cabinet.

16. The method of claim 15, wherein the rear face is an access door of the cabinet.
